(19) United States
(12) Patent Application Publication
(10) Pub. No.: US 2023/0407206 A1
(43) Pub. Date: Dec. 21, 2023

(54) FABRIC CONDITIONER

(71) Applicant: Conopco, Inc., d/b/a UNILEVER, Englewood Cliffs, NJ (US)

(72) Inventors: John Francis HUBBARD, Knutsford (GB); Wan HUNG, Liverpool (GB); John Francis WELLS, Neston (GB)

(73) Assignee: Conopco, Inc., d/b/a UNILEVER, Englewood Cliffs, NJ (US)

(21) Appl. No.: 18/037,155

(22) PCT Filed: Nov. 12, 2021
(86) PCT No.: PCT/EP2021/081583

§ 371 Date: May 16, 2023

(30) Foreign Application Priority Data
Nov. 18, 2020 (EP) 20208506.4

(51) Int. Cl. C11D 3/00; C11D 1/722; C11D 3/50; C11D 17/00; C11D 11/00; C11D 3/30

(52) U.S. Cl. CPC C11D 3/0015; C11D 1/722; C11D 3/505; C11D 17/0008; C11D 11/0017; C11D 3/30

(57) ABSTRACT

A method of in home preparation of a fabric conditioner, wherein an aqueous concentrated fabric conditioner comprising: a. 10 to 50 wt. % ester linked quaternary ammonium compound; and b. Non-ionic surfactant; is mixed with water to produce an aqueous fabric conditioner composition, wherein the ratio of non-ionic surfactant to fabric softening active is 1:10 to 1:40 by weight and the ratio of concentrated fabric conditioner composition to water is 1:20 to 1:1 by weight. A method of producing the concentrated aqueous fabric conditioner, said method comprising the step of: a. Mixing a fabric softening active and non-ionic surfactant to form a pre-mix at a temperature above 50° C.; b. Adding the premix to an aqueous composition comprising water.

### FIELD OF THE INVENTION

The present invention is in the field of providing an aqueous concentrated fabric conditioner composition for diluting at home to produce a ready to use fabric conditioner.

### BACKGROUND OF THE INVENTION

Consumers are becoming more conscious of the environmental impact of the products they use. In particular, consumers are concerned with the vast amount of packaging used in their everyday lives. There is a need for more concentrated products, which can provide the same consumer benefits, but with a lower environmental impact. One solution is to sell ‘concentrated’ products which the consumer can dilute at home with water. This reduces the amount of packaging required and reduces the weight/quantity of product being transported thereby having a positive impact on carbon emissions.

However, a problem arises since high concentrations of cationic fabric softening compounds lead to thick formulations, which require vigorous mixing to disperse in water. Fabric conditioners are routinely sold in ˜2 litre bottles. At home, many consumers would struggle with to sufficiently mix a concentrated product with the required amount of water due to the size and weight of the bottle.

The problem of viscosity is disclosed in WO 2007/141310 which discloses a stable, concentrated (pre-dilute) aqueous fabric softening composition. However, the inclusion of polymers involves extra processing steps.

There remains a need for concentrated dilute at home fabric conditioners which can spontaneously mix with water or require minimal mixing to prepare a diluted fabric conditioner formulation suitable for use.

### SUMMARY OF THE INVENTION

In a first aspect of the present invention is provided an aqueous concentrated fabric conditioner suitable for in home dilution, the concentrated fabric conditioner comprising:
a. 10 to 50 wt. % cationic fabric softening active; and
b. Non-ionic surfactant;
   wherein the ratio of non-ionic surfactant to fabric softening active is 1:5 to 1:60 by weight.

In a second aspect of the present invention is provided a method of in home preparation of a fabric conditioner, wherein an aqueous concentrated fabric conditioner comprising:
a. 10 to 50 wt. % fabric softening active; and
b. Non-ionic surfactant;
   is mixed with water to produce an aqueous fabric conditioner composition.

In a third aspect of the present invention is provided a method of producing an aqueous fabric conditioner suitable for in home dilution, said method comprising the step of:
a. Mixing a fabric softening active and non-ionic surfactant to form a pre-mix at a temperature above 50° C.;
b. Adding the premix to an aqueous composition comprising water.

### DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

Fabric Softening Active

The concentrated compositions described herein comprise a fabric softening active. Preferably the fabric conditioners of the present invention comprise more than 10 wt. % fabric softening active, more preferably more than 15 wt. % fabric softening active, most preferably more than 20 wt. % fabric softening active by weight of the composition. Preferably the fabric conditioners of the present invention comprise less than 50 wt. % fabric softening active, more preferably less than 45 wt. % fabric softening active, most preferably less than 40 wt. % fabric softening active by weight of the composition. Suitably the fabric conditioners comprise 10 to 50 wt. % fabric softening active, preferably 15 to 45 wt. % fabric softening active and more preferably 20 to 40 wt. % fabric softening active by weight of the composition.

The fabric softening actives are cationic materials. Suitable cationic fabric softening actives are described herein.

The preferred softening actives for use in fabric conditioner compositions of the invention are quaternary ammonium compounds (QAC).

The QAC preferably comprises at least one chain derived from fatty acids, more preferably at least two chains derived from a fatty acids. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

The preferred quaternary ammonium fabric softening actives for use in compositions of the present invention are so called “ester quats” or ester linked quaternary ammonium compounds. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of quaternary ammonium compounds (QACs) suitable for use in the present invention is represented by formula (I):

[(CH₂)ₙ(TR)]ₘ

R¹—N′—[(CH₂)ₙ(OH)]₃₋ₘX⁻ (I)

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X— is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of QACs suitable for use in the invention is represented by formula (II):

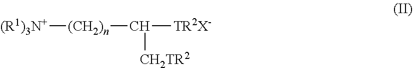

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X— are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ-T-R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X— are as defined above. Preferred materials of this third group include bis(2-tallowoyloxyethyl)dimethyl ammonium chloride, partially hardened and hardened versions thereof.

A particular example of the fourth group of QACs is represented the by the formula:

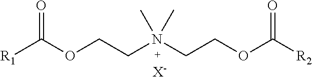

A fourth group of QACs suitable for use in the invention are represented by formula (V)

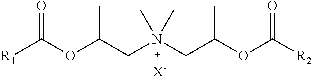

R1 and R2 are independently selected from C10 to C22 alkyl or alkenyl groups, preferably C14 to C20 alkyl or alkenyl groups. X— is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of quaternary ammonium materials present in the composition, the iodine value, referred to above, represents the mean iodine value of the parent fatty acyl compounds or fatty acids of all the quaternary ammonium materials present. Likewise, if there are any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem., 34, 1136 (1962) Johnson and Shoolery.

A further type of softening compound may be a non-ester quaternary ammonium material represented by formula (VI):

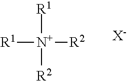

wherein each R1 group is independently selected from C1 to C4 alkyl, hydroxyalkyl or C2 to C4 alkenyl groups; R2 group is independently selected from C8 to C28 alkyl or alkenyl groups, and X— is as defined above.

Non-Ionic Surfactants

The concentrated compositions described herein comprise a non-ionic surfactant. The non-ionic surfactant provides spontaneous mixing between the concentrated fabric conditioners described herein and water when the concentrate is combined with water.

Preferred non-ionic surfactants include addition products of ethylene oxide and/or propylene oxide with fatty alcohols, fatty acids and fatty amines and combinations thereof. These are preferably selected from addition products of (a) an alkoxide selected from ethylene oxide, propylene oxide and mixtures thereof with (b) a fatty material selected from fatty alcohols, fatty acids and fatty amines and combinations thereof.

Preferred non-ionic surfactants are substantially water soluble surfactants of the general formula (VII):

R—Y—(C2H4O)z-CH2-CH2-OH (VII)

wherein
R is selected from the group consisting of primary, secondary and branched chain alkyl and/or acyl hydrocarbyl groups (when Y=—C(O)O, R≠an acyl hydrocarbyl group); primary, secondary and branched chain alkenyl hydrocarbyl groups; and primary, secondary and branched chain alkenyl-substituted phenolic hydrocarbyl groups; the hydrocarbyl groups having a chain length of from 10 to 60, preferably 10 to 25, e.g. 14 to 20 carbon atoms.

Y is selected from:
—O—, —C(O)O—, —C(O)N(R)— or —C(O)N(R)R—

R has the meaning given above for formula (VII), or can be hydrogen; and

Z is at least about 6, preferably at least about 10, more preferably at least 15.

Preferably R is selected from the group consisting of primary, secondary and branched chain alkyl and/or acyl hydrocarbyl groups (when Y=—C(O)O, R≠an acyl hydrocarbyl group). More preferably R is a primary alkyl group having a chain length of from 10 to 60, preferably 10 to 25, most preferably 14 to 20 carbon atoms.

Preferably Y is —O—.

Preferably z is 14 to 49, more preferably 14 to 34, most preferably 19-29.

An example of a suitable preferred non-ionic surfactant is Lutensol™ AT25 (BASF) based on C16:18 chain and 25 EO groups. Other suitable surfactants include Renex 36 (Trideceth-6), ex Croda; Tergitol 15-S3, ex Dow Chemical Co.; Dihydrol LT7, ex Thai Ethoxylate ltd; Cremophor C040, ex BASF and Neodol 91-8, ex Shell.

Preferably the compositions comprise 0.3 to 5 wt. % non-ionic surfactant, more preferably 0.4 to 4 wt. % non-ionic surfactant.

Ratio of Non-Ionic Surfactant to Fabric Softening Active

The ratio of non-ionic surfactant to fabric softening active calculated on wt. % is 1:10 to 1:40 and most preferably 1:20 to 1:35.

Perfume

The concentrated compositions described herein preferably comprise perfume. Where present, the compositions preferably comprise 0.1 to 30 wt. % perfume materials, i.e. free perfume and/or perfume microcapsules. As is known in the art, free perfumes and perfume microcapsules provide the consumer with perfume hits at different points during the laundry process. It is particularly preferred that the compositions of the present invention comprise a combination of both free perfume and perfume microcapsules.

Preferably the compositions of the present invention comprise 0.5 to 20 wt. % perfume materials, more preferably 1 to 15 wt. % perfume materials, most preferably 1 to 10 wt. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

The compositions of the present invention preferably comprises 0.1 to 15 wt. % free perfume, more preferably 0.5 to 8 wt. % free perfume.

Particularly preferred perfume components are blooming perfume components and substantive perfume components. Blooming perfume components are defined by a boiling point less than 250° C. and a LogP or greater than 2.5. Substantive perfume components are defined by a boiling point greater than 250° C. and a LogP greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The compositions of the present invention preferably comprise 0.1 to 15 wt. % perfume microcapsules, more preferably 0.2 to 8 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. B looming perfume components are defined by a boiling point less than 250° C. and a LogP greater than 2.5. Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a LogP greater than 2.5. Preferably the encapsulated perfume compositions comprises at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

Co-Softeners

Co-softeners may be used. When employed, they are typically present at from 0.1 to 20% and particularly at from 0.5 to 10%, based on the total weight of the composition. Preferred co-softeners include fatty esters, and fatty N-oxides. Fatty esters that may be employed include fatty monoesters, such as glycerol monostearate, fatty sugar esters, such as those disclosed WO 01/46361 (Unilever).

The compositions of the present invention may comprise a fatty complexing agent. Especially suitable fatty complexing agents include fatty alcohols and fatty acids. Of these, fatty alcohols are most preferred.

Without being bound by theory it is believed that the fatty complexing material improves the viscosity profile of the composition by complexing with mono-ester component of the fabric conditioner material thereby providing a composition which has relatively higher levels of di-ester and tri-ester linked components. The di-ester and tri-ester linked components are more stable and do not affect initial viscosity as detrimentally as the mono-ester component.

It is also believed that the higher levels of mono-ester linked component present in compositions comprising quaternary ammonium materials based on TEA may destabilise the composition through depletion flocculation. By using the fatty complexing material to complex with the mono-ester linked component, depletion flocculation is significantly reduced.

In other words, the fatty complexing agent at the increased levels, as required by the present invention, “neutralises” the mono-ester linked component of the quaternary ammonium material. This in situ di-ester generation from mono-ester and fatty alcohol also improves the softening of the composition.

Preferred fatty acids include tallow fatty acid or vegetable fatty acids, particularly preferred are hardened tallow fatty acid or hardened vegetable fatty acid (available under the trade name Pristerene™, ex Croda). Preferred fatty alcohols include tallow alcohol or vegetable alcohol, particularly preferred are hardened tallow alcohol or hardened vegetable alcohol (available under the trade names Stenol™ and Hydrenol™, ex BASF and Laurex™ CS, ex Huntsman).

The fatty complexing agent is preferably present in an amount greater than 0.3 to 5% by weight based on the total weight of the composition. More preferably, the fatty component is present in an amount of from 0.4 to 4%. The weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

Preservatives

The concentrated compositions as described herein preferably comprise preservatives, either a single preservative or a combination of preservatives. The level of preservatives is important to ensure preservation both before and after dilution of the concentrated formulations. Two preferred classes of preservatives are organic acid and/or the salts thereof and isothiazolinones. Examples of organic acid and/or the salts thereof are potassium sorbate and sodium benzoate. Examples of isothiazolinones are Methylisothiazolinone (MIT), Chloromethylisothiazolinone (CMIT) and Benzisothiazolinone (BIT). Generally, preservatives are preferably included at an inclusion level of 0.005 to 1 wt. %, more preferably 0.01 to 0.8 wt. %. Preferred inclusion levels of organic acid and/or the salts thereof are 0.2 to 0.8 wt. % and preferred inclusion levels of isothiazolinones is 0.01 to 0.05 wt. %.

Other Ingredients

The concentrated compositions described herein may comprise other ingredients of fabric conditioner liquids as will be known to the person skilled in the art. Among such materials there may be mentioned: antifoams, insect repellents, shading or hueing dyes, anti-bacterial agents, anti-virus agents, pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

Form of the Invention

The concentrated compositions described herein are aqueous compositions. The compositions preferably comprise more than 40 wt. % water, more preferably more than 50 wt. % water.

Method of Manufacture

In one aspect of the present invention is provided a method of producing an aqueous fabric conditioner suitable for in home dilution, preferably an aqueous fabric conditioner as described herein, said method comprising the step of:
a. Mixing a fabric softening active and non-ionic surfactant to form a pre-mix;
b. Adding the premix to an aqueous composition comprising water.

Preferably in step a, the fabric softening active and non-ionic surfactant are heated to a temperature above 50° C., more preferably above 55° C., most preferably above 60° C.

The aqueous compositions in step b may comprise other ingredients. Additional ingredients may be added after the premix.

Preferably the aqueous composition comprising water comprising water in step b is at a temperature of above 40° C., preferably above 45° C. Preferably any free perfume is added after cooling the composition below 40° C.

Method of Diluting

In one aspect of the present invention is a provided a method of in home preparation of a fabric conditioner, wherein an aqueous concentrated fabric conditioner as described herein is mixed with water to produce an aqueous fabric conditioner composition. The mixing, or dilution takes place prior to the laundry process. The fabric conditioner prepared by the method described herein can then be used in a laundry process. The laundry process is defined as the process in which clothes are washed, rinsed and dried. In other words the mixing with water takes place before the fabric conditioner composition is added to the washing machine (drum or drawer) or before the fabric conditioner is added to the receptacle in which hand washing occurs. The consumer may prepare the liquid fabric conditioner just before the laundry process or may prepare the liquid fabric conditioner days or weeks before using it in the laundry process.

The concentrated fabric conditioning composition may be diluted with water in any suitable receptacle, for example a bottle, a jug, a pot, a box, a bowl, i.e. any container suitable for containing a liquid composition. Preferably the receptacle has means for closing the receptacle, i.e. for sealing the liquid fabric conditioner composition within the receptacle, for example a lid. Preferably a bottle is used, preferably the bottle has a lid.

Generally, the consumer may have a ‘keeper’ bottle. This may be a bottle provided especially for the purpose of mixing and storing the diluted fabric conditioner or may be an old bottle previously purchased. The ‘keeper’ bottle is kept and reused with subsequent purchases of dilutable concentrated products.

Either the water or concentrated fabric conditioner composition may be placed in the receptacle first. However, preferably the water is placed in the receptacle, followed by the concentrated fabric conditioner composition. This prevents foaming.

Although mixing may not be necessary, the consumer may shake or stir the diluted composition to ensure full dispersal of the concentrated fabric conditioner in the water.

Once the diluted fabric conditioner is made, this may be used according to regular dossing habits.

Preferably the ratio of concentrated fabric conditioner composition to water is 1:20 to 1:1 by weight, preferably 1:10 to 1:1.5, more preferably 1:10 to 1:2.

### EXAMPLES

The effect of a non-ionic surfactant for a dilute at home formulation was assessed as follows:

TABLE 1
Example compositions

Wt. % active

| | A | 1 |
|---|---|---|
| Fabric softening active¹ | 24 | 24 |
| Non-ionic surfactant² | 0 | 1 |
| Preservative | 0.75 | 0.75 |
| Minors | <1 | <1 |
| Water | To 100 | To 100 |

Fabric Softening active¹ - TEA quaternary ammonium compound according to formula (I) above

Non-Ionic Surfactant²—Lutensol AT-25 Ex BASF.

The compositions were prepared by the following method. The fabric softening active and non-ionic surfactant (where present) were heated together to a temperature of 65° C. to for a pre-melt. Separately water was heated to ˜50° C., some minors and preservative were added with stirring. The pre-mix was slowly added with stirring. The formulation was cooled and stored at ambient conditions.

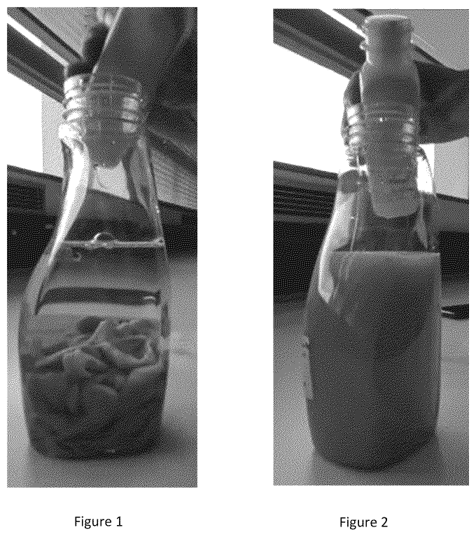

250 ml of each composition (A and 1) were each poured into identical bottles comprising 500 ml of water (dilution ratio of 1:2). A photograph was taken immediately after adding the 250 ml of concentrated compositions to the water. FIG. 1 is the photograph after adding composition A to water. FIG. 2 is the photograph after adding composition 1 to the water. As demonstrated by the figures, composition 1 spontaneously disperses in the water, whereas composition A does not mix with the water and will require stirring and/or shaking to disperse in the water.

We claim:

1-8. (canceled)

9. A method of in-home preparation of an aqueous fabric conditioner composition,
wherein an aqueous concentrated fabric conditioner composition comprising:
a. 10 to 50 wt. % ester linked quaternary ammonium compound; and
b. non-ionic surfactant
is mixed with water to produce the aqueous fabric conditioner composition,
further wherein the non-ionic surfactant to quaternary ammonium compound is at a ratio of 1:20 to 1:40 by weight and the ratio of concentrated fabric conditioner composition to water is 1:20 to 1:1 by weight.

10. The method according to claim 9, wherein the concentrated fabric conditioner composition comprises 0.3 to 5 wt. % non-ionic surfactant.

11. The method according to claim 9, wherein the non-ionic surfactant comprises surfactants selected from addition products of ethylene oxide and/or propylene oxide with fatty alcohols, fatty acids and fatty amines and combinations thereof.

12. The method according to claim 9, wherein the non-ionic surfactant comprises surfactants having a general formula (VII):
R—Y—(C2H4O)z-CH2-CH2-OH
wherein R is selected from the group consisting of primary, secondary and branched chain alkyl and/or acyl hydrocarbyl groups when Y=—C(O)O, R≠an acyl hydrocarbyl group; primary, secondary and branched chain alkenyl hydrocarbyl groups; and primary, secondary and branched chain alkenyl-substituted phenolic hydrocarbyl groups; the hydrocarbyl groups having a chain length from 10 to 60, and combinations thereof;
Y is selected from: —O—, —C(O)O—, —C(O)N(R)— or —C(O)N(R)R— in which R is as previously defined, or can be hydrogen; and
Z is at least 6.

13. The method according to claim 9, wherein the concentrated fabric conditioner composition further comprises free perfume.

14. The method according to claim 9, wherein the concentrated fabric conditioner composition further comprises encapsulated perfume.

15. The method according to any preceding claim 9, wherein the concentrated fabric conditioner composition further comprises preservatives.

16. A method for producing an aqueous concentrated fabric conditioner composition, said method comprising the steps of:
a. mixing a fabric softening active and non-ionic surfactant to form a pre-mix at a temperature above 50° C.;
b. adding the premix to an aqueous composition comprising water; and
c. recovering the aqueous concentrated fabric conditioner.

17. The method for producing an aqueous concentrated fabric conditioner composition according to claim 16 wherein the aqueous concentrated fabric conditioner comprises perfume and preservative and further wherein the non-ionic surfactant to fabric softening active is at a ratio of 1:20 to 1:40 by weight, the aqueous concentrated fabric conditioner composition having antifoam, insect repellent, shading or hueing dye, antibacterial agent, anti-virus agent, pH buffering agent, perfume carrier, hydrotrope, anti-redeposition agent, soil-release agent, polyelectrolyte, anti-shrinking agent, anti-wrinkle agent, anti-oxidant, dye, colorant, sunscreen, anti-corrosion agent, drape imparting agent, anti-static agent, sequestrant, ironing aid, pearliser opacifier or a mixture thereof.
